(19) United States
(12) Patent Application Publication
(10) Pub. No.: US 2024/0070576 A1
(43) Pub. Date: Feb. 29, 2024

(54) INFORMATION PROCESSING APPARATUS, INFORMATION PROCESSING METHOD, AND NON-TRANSITORY COMPUTER READABLE MEDIUM

(71) Applicant: TOYOTA JIDOSHA KABUSHIKI KAISHA, Toyota-shi (JP)

(72) Inventors: Mitsuhiro MIURA, Nagoya-shi (JP); Kenichi YAMADA, Nisshin-shi (JP); Satoshi KOMAMINE, Nagoya-shi (JP); Fumiyuki KAGARA, Sagamihara-shi (JP); Go TANAKA, Toyota-shi (JP); Hiroyuki NISHIZAWA, Tokyo-to (JP)

(73) Assignee: TOYOTA JIDOSHA KABUSHIKI KAISHA, Toyota-shi (JP)

(21) Appl. No.: 18/455,202

(22) Filed: Aug. 24, 2023

(30) Foreign Application Priority Data
Aug. 24, 2022 (JP) 2022-133472

(51) Int. Cl. G06Q 10/0631; G06Q 10/087

(52) U.S. Cl. CPC G06Q 10/063112; G06Q 10/063114; G06Q 10/087

(57) ABSTRACT

An information processing apparatus includes a memory that stores information on a package to be transported by a vehicle traveling within a site of a factory and attributes of each employee working at the factory, a controller that sets a condition on an employee who can be in charge of loading or unloading the package and formulates a transportation plan for the package based on the information on the package, and identifies at least one employee who has attributes satisfying the condition, from among one or more employees scheduled to ride in the vehicle transporting the package, based on the attributes of each employee and the condition on the employee who can be in charge of loading or unloading the package, and a communication interface that notifies a mobile terminal carried by the at least one employee of a request for loading or unloading the package.

### CROSS-REFERENCE TO RELATED APPLICATION

This application claims priority to Japanese Patent Application No. 2022-133472 filed on Aug. 24, 2022, the entire contents of which are incorporated herein by reference.

### TECHNICAL FIELD

The present disclosure relates to an information processing apparatus, an information processing method, and a non-transitory computer readable medium.

### BACKGROUND

Technology for transporting people and goods in mixed freight and passenger loads is known. For example, Patent Literature (PTL) 1 discloses allowing users to ride in the open space of an autonomous vehicle that delivers packages.

### CITATION LIST

### Patent Literature

PTL 1: JP 2020-149576 A

### SUMMARY

Technology for transporting people and goods in mixed freight and passenger loads has room for improvement.

It would be helpful to improve technology for transporting people and goods in mixed freight and passenger loads.

An information processing apparatus according to an embodiment of the present disclosure is an information processing apparatus for managing loading or unloading of a package and includes:
a memory configured to store information on the package to be transported by a vehicle traveling within a site of a factory and attributes of each employee working at the factory;
a controller configured to set a condition on an employee who can be in charge of loading or unloading the package and formulate a transportation plan for the package based on the information on the package, and identify at least one employee who has attributes satisfying the condition, from among one or more employees who are scheduled to ride in the vehicle that is to transport the package, based on the attributes of each employee and the condition on the employee who can be in charge of loading or unloading the package; and
a communication interface configured to notify a mobile terminal carried by the at least one employee of a request for loading or unloading the package.

An information processing method according to an embodiment of the present disclosure is an information processing method to be executed by an information processing apparatus for managing loading or unloading of a package, the information processing method including:
storing information on the package to be transported by a vehicle traveling within a site of a factory and attributes of each employee working at the factory;
setting a condition on an employee who can be in charge of loading or unloading the package based on the information on the package;
formulating a transportation plan for the package based on the information on the package;
identifying at least one employee who has attributes satisfying the condition, from among one or more employees who are scheduled to ride in the vehicle that is to transport the package, based on the attributes of each employee and the condition on the employee who can be in charge of loading or unloading the package; and
notifying a mobile terminal carried by the at least one employee of a request for loading or unloading the package.

A non-transitory computer readable medium according to an embodiment of the present disclosure stores a program configured to cause an information processing apparatus for managing loading or unloading of a package to execute operations, the operations including:
storing information on the package to be transported by a vehicle traveling within a site of a factory and attributes of each employee working at the factory;
setting a condition on an employee who can be in charge of loading or unloading the package based on the information on the package;
formulating a transportation plan for the package based on the information on the package;
identifying at least one employee who has attributes satisfying the condition, from among one or more employees who are scheduled to ride in the vehicle that is to transport the package, based on the attributes of each employee and the condition on the employee who can be in charge of loading or unloading the package; and
notifying a mobile terminal carried by the at least one employee of a request for loading or unloading the package.

According to an embodiment of the present disclosure, technology for transporting people and goods in mixed freight and passenger loads is improved.

### BRIEF DESCRIPTION OF THE DRAWINGS

In the accompanying drawings:

FIG. 1 is a diagram illustrating a schematic configuration of an information processing system according to an embodiment of the present disclosure;

FIG. 2 is a block diagram illustrating a schematic configuration of the information processing system; and

FIG. 3 is a flowchart illustrating operations of an information processing apparatus.

### DETAILED DESCRIPTION

Hereinafter, an embodiment of the present disclosure will be described.

### Outline of Embodiment

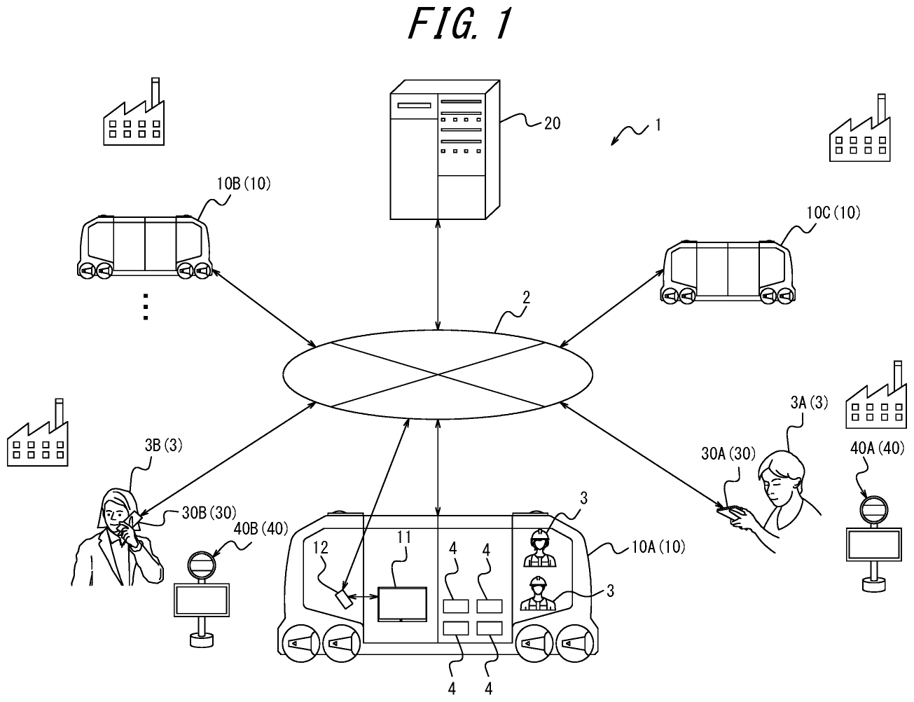

With reference to FIG. 1, an information processing system 1 according to an embodiment of the present disclosure will be described. The information processing system 1 includes a vehicle 10, an information processing apparatus 20, and a mobile terminal 30. The vehicle 10, the information processing apparatus 20, and the mobile terminal 30 are communicably connected to a network 2 including, for example, the Internet, a mobile communication network, and the like.

The vehicle 10 is an automobile, for example, but is not limited to this, and may be any appropriate vehicle. The automobile is a gasoline vehicle, a Battery Electric Vehicle (BEV), a Hybrid Electric Vehicle (HEV), a Plug-in Hybrid Electric Vehicle (PHEV), a Fuel Cell Electric Vehicle (FCEV), or the like, but is not limited to these. The number of vehicles 10 included in the information processing system 1 may be freely determined.

In the present embodiment, the vehicle 10 travels within a predetermined factory site. The factory site contains an office where employees work, buildings for the factory, and the like. The vehicle 10 may travel anywhere other than within the factory site. However, in the present embodiment, the vehicle 10 circulates over a predetermined route in the factory site. The route over which the vehicle 10 circulates includes at least one stop 40 (for example, 40A, 40B).

The vehicle 10 is capable of transporting people and goods in mixed freight and passenger loads. In other words, the vehicle 10 can transport employees 3 and a package 4 together. Employees working at the factory have access, for example, to vehicles for transportation within the site. For example, the employees 3 get on the vehicle 10 at the stops 40 and get off the vehicle 10 at the stops 40. The package 4 to be transported by the vehicle 10 is, for example, equipment used in the factory, materials used in production in the factory, or the like. The package 4 is loaded onto the vehicle 10 at the stops 40 and unloaded from the vehicle 10 at the stops 40.

In the present embodiment, the employee 3 who uses the vehicle 10 for transportation loads the package when getting on and unloads when getting off in response to a request from the information processing apparatus 20. For example, the employee 3 loads the package 4 when getting on the vehicle 10 at stop 40A or 40B. The employee 3 then unloads the package 4 when getting off the vehicle 10 at stop 40B or 40A.

The information processing apparatus 20 manages the loading or unloading of the package 4. The information processing apparatus 20 is, for example, a computer such as a server apparatus. The information processing apparatus 20 can communicate with the vehicle 10 and the mobile terminal 30 via the network 2.

The mobile terminal 30 is a mobile information terminal carried by the employee 3 working at the factory on the site, receives notifications from the information processing apparatus 20, and transmits responses to the information processing apparatus 20. The mobile terminal 30 is, for example, a mobile phone, a smartphone, a tablet, a personal computer (PC), or the like. The mobile terminal 30 can communicate with the vehicle 10 and the information processing apparatus 20 via the network 2.

First, an outline of the present embodiment will be described, and details thereof will be described later. The information processing apparatus forming part of the information processing system 1 sets a condition on an employee who can be in charge of loading or unloading of a package to be transported by a vehicle traveling within a site of a factory and formulates a transportation plan for the package based on information on the package, identifies at least one employee who has attributes satisfying the condition, from among one or more employees scheduled to ride in the vehicle 10 transporting the package, based on the attributes of each employee and the condition on the employee who can be in charge of loading or unloading the package, and notifies the mobile terminal 30 carried by the employee of a request for loading or unloading the package. The information processing apparatus 20 is, for example, a dedicated computer configured to function as a server, a general purpose personal computer, a cloud computing system, or the like.

According to the present embodiment, the information processing apparatus 20 can thus set a condition on an employee who can be in charge of loading or unloading the package, identify an employee who can be in charge of loading or unloading the package based on the condition, and issue a request to the employee to load or unload the package. Therefore, compared to a case in which any employee is requested to perform loading or the like without imposing conditions on the employee who performs the loading or the like of the package, the technology for transporting people and goods in mixed freight and passenger loads is improved by a reduction in the probability of inconveniences such as damage to a package occurring as a result of loading or the like being performed by an employee who does not meet the conditions.

Next, configurations of the information processing system 1 will be described in detail.

(Configuration of Vehicle)

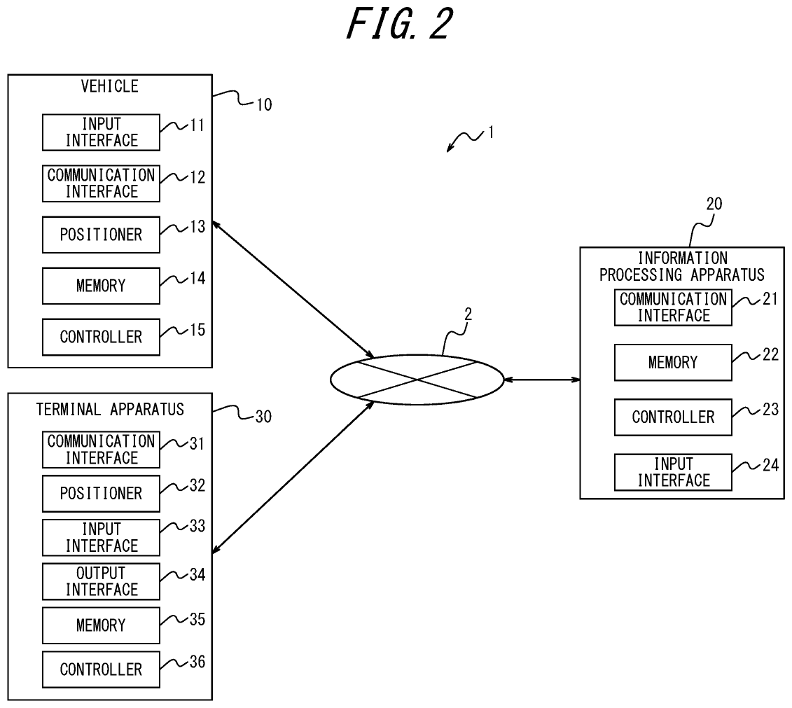

As illustrated in FIG. 2, the vehicle 10 includes an input interface 11, a communication interface 12, a positioner 13, a memory 14, and a controller 15.

The input interface 11 is capable of accepting an input from the employee. The input interface 11 is configured to include at least one interface for input that is capable of accepting an input from the employee. The interface for input is, for example, a physical key, a capacitive key, a pointing device, a touch screen integrally provided with the display, a barcode reader, an IC card reader, a microphone, or the like. However, the interface for input is not limited to this.

The communication interface 12 includes at least one interface for communication for connecting to the network 2. The communication interface is compliant with mobile communication standards such as the 4th generation (4G) standard or the 5th generation (5G) standard, for example, but these examples are not limiting. In the present embodiment, the vehicle 10 communicates with the information processing apparatus 20 via the communication interface 12 and the network 2.

The positioner 13 includes one or more apparatuses configured to acquire positional information for the vehicle 10. Specifically, the positioner 13 includes, for example, a receiver compliant with GPS, but is not limited to this example and may include a receiver compliant with any appropriate satellite positioning system.

The memory 14 includes one or more memories. The memories are semiconductor memories, magnetic memories, optical memories, or the like, for example, but are not limited to these. The memories included in the memory 14 may each function as, for example, a main memory, an auxiliary memory, or a cache memory. The memory 14 stores any information used for operations of the vehicle 10. For example, the memory 14 may store a system program, an application program, embedded software, and the like. The information stored in the memory 14 may be updated with, for example, information acquired from the network 2 via the communication interface 12.

The controller 15 includes at least one processor, at least one programmable circuit, at least one dedicated circuit, or a combination of these. The processor is a general purpose processor such as a central processing unit (CPU) or a graphics processing unit (GPU), or a dedicated processor that is dedicated to specific processing, for example, but is not limited to these. The programmable circuit is a field-programmable gate array (FPGA), for example, but is not limited to this. The dedicated circuit is an application specific integrated circuit (ASIC), for example, but is not limited to this. The controller 15 controls the operations of the entire vehicle 10.

(Configuration of Information Processing Apparatus)

As illustrated in FIG. 2, the information processing apparatus 20 includes a communication interface 21, a memory 22, a controller 23, and an input interface 24.

The communication interface 21 includes at least one interface for communication for connecting to the network 2. The communication interface may be compliant with, for example, mobile communication standards, wired local area network (LAN) standards, or wireless LAN standards, but these examples are not limiting. The communication interface may be compliant with any appropriate communication standards. In the present embodiment, the information processing apparatus 20 communicates with the vehicle 10 via the communication interface 21 and the network 2. The information processing apparatus 20 communicates with the mobile terminal 30 carried by the employee via the communication interface 21 and the network 2.

The memory 22 includes one or more memories. The memories included in the memory 22 may each function as, for example, a main memory, an auxiliary memory, or a cache memory. The memory 22 stores any information used for operations of the information processing apparatus 20. For example, the memory 22 may store a system program, an application program, a database, map information, and the like. The information stored in the memory 22 may be updated with, for example, information acquired from the network 2 via the communication interface 21.

The controller 23 includes at least one processor, at least one programmable circuit, at least one dedicated circuit, or a combination of these. The controller 23 controls the operations of the entire information processing apparatus 20.

The input interface 24 is capable of accepting an input from the employee. The input interface 24 is configured to include at least one interface for input that is capable of accepting an input from the employee. The interface for input is, for example, a physical key, a capacitive key, a pointing device, a touch screen integrally provided with the display, a barcode reader, an IC card reader, a microphone, or the like. However, the interface for input is not limited to this.

(Mobile Terminal Configuration)

As illustrated in FIG. 2, the mobile terminal 30 includes a communication interface 31, a positioner 32, an input interface 33, an output interface 34, a memory 35, and a controller 36.

The communication interface 31 is configured to include at least one communication module for connection to the network 2. The communication module is, for example, a communication module compliant with a mobile communication standard such as LTE, 4G, or 5G. However, the communication module is not limited to this. The communication module may be compliant with any communication standard.

The positioner 32 is capable of acquiring positional information on the mobile terminal 30. The positioner 32 is configured to include at least one receiving module corresponding to a satellite positioning system. The receiving module is, for example, a receiving module corresponding to the GPS. The receiving module is not, however, limited to this example. The receiving module may be a receiving module corresponding to any appropriate satellite positioning system.

The input interface 33 is capable of accepting an input from the employee. The input interface 33 is configured to include at least one interface for input that is capable of accepting an input from the employee. The interface for input is, for example, a physical key, a capacitive key, a pointing device, a touch screen integrally provided with a display, a microphone, or the like. However, the interface for input is not limited to this.

The output interface 34 is capable of outputting data. The output interface 34 is configured to include at least one interface for output that is capable of outputting data. The interface for output is, for example, a display, a speaker, or the like. The display is, for example, an LCD, an organic EL display, or the like. However, the interface for output is not limited to this.

The memory 35 is configured to include at least one semiconductor memory, at least one magnetic memory, at least one optical memory, or a combination of at least two of these. The semiconductor memory is, for example, RAM, ROM, or the like. The RAM is, for example, SRAM, DRAM, or the like. The ROM is, for example, EEPROM or the like. The memory 35 may function as a main memory, an auxiliary memory, or a cache memory. The memory 35 stores data to be used for the operations of the mobile terminal 30 and data obtained by the operations of the mobile terminal 30.

The controller 36 is configured to include at least one processor, at least one dedicated circuit, or a combination thereof. The processor is, for example, a general purpose processor such as a CPU or a GPU, or a dedicated processor that is dedicated to a specific process. The dedicated circuit is, for example, an FPGA, an ASIC, or the like. The controller 36 executes processes related to operations of the mobile terminal 30 while controlling components of the mobile terminal 30.

The functions of the mobile terminal 30 are realized by execution of a terminal program according to the present embodiment by a processor corresponding to the controller 36. That is, the functions of the mobile terminal 30 are realized by software. The terminal program causes a computer to execute the operations of the mobile terminal 30, thereby causing the computer to function as the mobile terminal 30. That is, the computer executes the operations of the mobile terminal 30 in accordance with the terminal program to thereby function as the mobile terminal 30.

Some or all of the functions of the mobile terminal 30 may be realized by a dedicated circuit corresponding to the controller 36. That is, some or all of the functions of the mobile terminal 30 may be realized by hardware.

The controller 36 controls the positioner 32 to acquire positional information on the mobile terminal 30. The controller 36 controls the communication interface 31 to transmit, to the information processing apparatus 20 via the network 2, the acquired positional information on the mobile terminal 30, together with identification information on the employee carrying the mobile terminal 30. The identification information on the employee is information capable of uniquely identifying the employee. The controller 36 may acquire, at established time intervals, the positional information on the mobile terminal 30 and transmit the acquired positional information on the mobile terminal 30, together with the identification information on the employee, to the information processing apparatus 20. The time intervals may be set based on, for example, the average speed at which the mobile terminal 30 moves.

(Flow of Operations of Information Processing Apparatus 20)

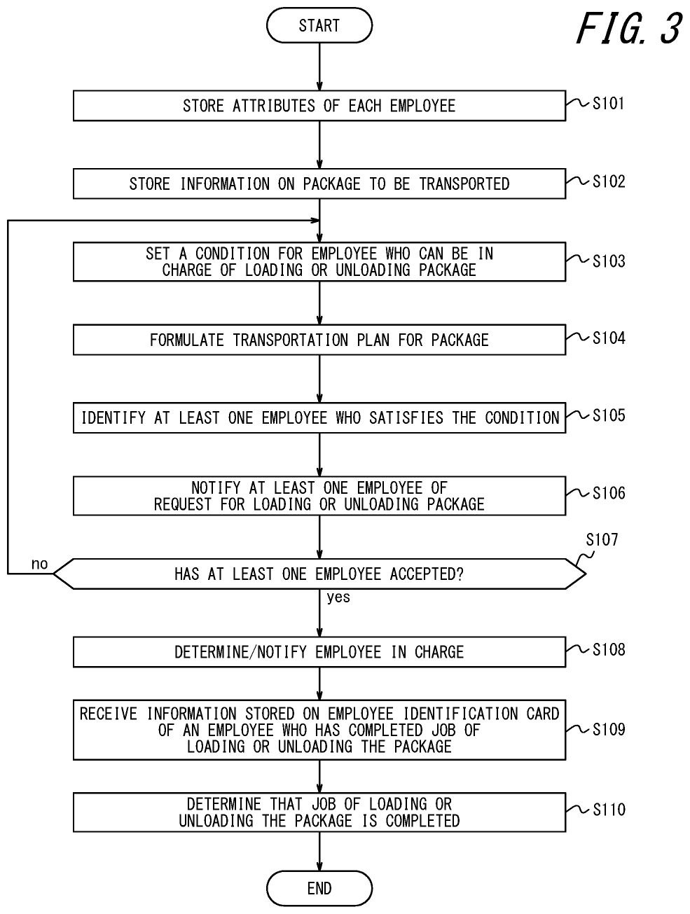

Operations of the information processing apparatus 20 according to the present embodiment will be described with reference to FIG. 3.

Step S101: the memory 22 of the information processing apparatus 20 stores the attributes of each employee working at the factory.

The attributes of the employees include at least one of a respective department, job responsibilities, work of which the employee is in charge, age, health status, and experience in handling equipment or materials that are packages to be transported by the vehicle. The department, job responsibilities, and work of which the employee is in charge are referred to in determining whether each employee is in a position operationally related to the package to be transported. The age and health status are referred to in determining whether each employee is physically capable of transporting the package. The experience in handling equipment or materials is referred to in determining whether each employee is capable of properly handling the equipment or materials in a case in which handling is prohibited by law, the equipment may be damaged, or handling is hazardous unless the employee has specialized knowledge, qualifications, experience, or the like in handling the equipment or materials.

Step S102: the memory 22 of the information processing apparatus 20 stores information on the package to be transported by the vehicle 10 traveling within the site of the factory.

The information on the package includes at least one of a configuration of equipment or materials, handling information, a volume, a weight, a safety data sheet, a pickup location for the package, a pickup time, a loading stop, a loading time, an unloading stop, an unloading time, a delivery location, and a delivery time. The configuration of the equipment or materials, handling information, volume, weight, and safety data sheet are referred to in step S103, described below, in setting the condition on the employee who can be in charge of loading or unloading the package. The loading stop, loading time, unloading stop, and unloading time are referred to in step S104, described below, in formulating the transportation plan for the package. Use of the pickup location, pickup time, delivery location, and delivery time is described below.

Step S103: the controller 23 of the information processing apparatus sets a condition for the employee who can be in charge of loading or unloading the package based on the information on the package.

In greater detail, the controller 23 refers to the information on the package stored in the memory 22 and sets the conditions required of the employee who is to load or unload the package onto or off of the vehicle. For example, conditions on the configuration and the handling information for the equipment or materials, the employee's department, job responsibilities, work of which the employee is in charge, and the like are narrowed down. As an example, in a case in which the handling information indicates a specific department that is allowed to handle the equipment or materials, a condition of belong to that specific department may be set. Conditions on the physical ability of the employee are also narrowed down based on the volume and weight. Furthermore, conditions on the specialized knowledge, qualifications, experience, and the like required of the employee are narrowed down based on the safety data sheet. The conditions narrowed down based on such information on the package are set as the conditions for the employee who can be in charge of loading or unloading the package. The conditions on the employee who can be in charge of loading or unloading the package may include at least the requirement that the employee have experience in handling the equipment or materials. The reason is that experience in handling the equipment or materials is an important condition for employee safety and for avoiding damage to the equipment or materials.

Step S104: the controller 23 of the information processing apparatus 20 formulates a transportation plan for the package based on the information on the package.

The information on the package includes the loading stop for the package, the loading time, the unloading stop, and the unloading time. Based on such information, a transportation plan for the package is formulated, including the loading stop for the package, the vehicle on which the package is to be loaded, the loading time, the unloading stop, and the unloading time.

Step S105: the controller 23 of the information processing apparatus identifies at least one employee who has attributes satisfying the condition on the employee who can be in charge of loading or unloading the package, from among one or more employees who are scheduled to ride in the vehicle that is to transport the package for which the transportation plan was formulated, based on the attributes of each employee and the conditions on the employee who can be in charge of loading or unloading the package.

Based on the attributes of the employees working at the factory and the conditions on the employees who can be in charge, one or more employees who meet the conditions for loading or unloading the package are identified. It should be noted that it is a prerequisite for the identified employee to board the vehicle indicated in the transportation plan at a predetermined stop and at a predetermined time.

Step S106: the communication interface 21 of the information processing apparatus 20 notifies the mobile terminal 30 carried by the at least one employee of the request for loading or unloading the package, the request including the transportation plan for the package which includes the loading stop for the package, the loading time, the unloading stop, and the unloading time.

The information processing apparatus 20 notifies, via the network 2, the mobile terminal 30 carried by the at least one employee of the transportation plan for the package and also notifies of the request to load the package onto a predetermined vehicle at a predetermined stop and at a predetermined time or to unload the package from a predetermined vehicle at a predetermined stop and at a predetermined time. The information processing apparatus 20 may issue a request to both load and unload the package to the one or more employees.

Step S107: the controller 23 of the information processing apparatus confirms whether at least one of the one or more employees has accepted the request.

The employees notified of the request examine whether they can take charge of loading or unloading the package at the predetermined stop and at the predetermined time and respond to the communication interface 21 of the information processing apparatus 20 from the carried mobile terminal 30 via the network 2 to accept or decline the request. The controller 23 checks whether each of the one or more employees has accepted the request. In a case in which at least one of the one or more employees has accepted the request, the process advances to step S109. Conversely, in a case in which all of the one or more employees have declined the request, the process returns to step S103, and the condition on the employee who can take charge of loading or unloading the package is reviewed.

Step S108: in a case in which one or more employees have accepted the request, the controller 23 of the information processing apparatus 20 determines at least one of the one or more employees who accepted the request to be the employee who loads the package onto the vehicle or unloads the package from vehicle (hereinafter referred to as the employee in charge).

The controller 23 determines one of the employees who accepted the request to be the employee in charge. The controller 23 may determine two or more employees to be employees in charge based on the volume, weight, safety, or the like of the package to be transported. The controller 23 notifies each employee in charge of the decision via the communication interface 21.

Step S109: the communication interface 21 of the information processing apparatus 20 receives, from the vehicle 10 via the network 2, information stored on an employee identification card of an employee who has completed loading or unloading the package.

When the employee in charge has completed loading the package onto the vehicle 10 at a predetermined stop or unloading the package at a predetermined stop, the employee operates the input interface 11 to read the information stored on the employee identification card into the input interface 11 included in the vehicle 10. Operation of the input interface 11 refers, for example, to pressing a physical key or tapping an icon on the touch screen when the loading or unloading of the package is completed. Once a predetermined operation is performed, the input interface 11 requests reading of the employee identification card. A barcode printed on the employee identification card or an IC chip embedded in the employee identification card stores information on each employee's attributes, including the employee's department, job responsibilities, and work of which the employee is in charge. The input interface 11 is configured to include at least one interface for input that is capable of accepting an input from the employee. The interface for input is, for example, a physical key, a capacitive key, a pointing device, a touch screen integrally provided with the display, a barcode reader, an IC card reader, a microphone, or the like. The input interface 11 may use a barcode reader, IC card reader, or the like to read the information on the attributes stored on the employee identification card. The input interface 11 may also record, with a microphone or the like, information on the attributes of speech uttered by the employee. The controller 15 of the vehicle 10 transmits the information stored on the employee identification card, as inputted by performance of a predetermined operation by the employee who completed the work he or she was in charge of, to the communication interface 21 of the information processing apparatus 20 via the communication interface 12 and the network 2.

Step S110: upon acquiring the information stored in the employee identification card of the employee in charge of loading or unloading the package, the controller 23 of the information processing apparatus 20 determines that the employee in charge has completed loading or unloading the package.

Upon the controller 23 determining that loading or unloading of the package by the employee in charge is completed, the information processing apparatus 20 terminates the processing for loading or unloading the package.

As described above, the information processing apparatus 20 according to the present embodiment sets a condition on an employee who can be in charge of loading or unloading of a package to be transported by a vehicle traveling within a site of a factory and formulates a transportation plan for the package based on information on the package, identifies at least one employee who has attributes satisfying the condition, from among one or more employees scheduled to ride in the vehicle 10 that is to transport the package, based on the attributes of each employee and the condition on the employee who can be in charge of loading or unloading the package, and notifies the mobile terminal 30 carried by the employee of a request for loading or unloading the package.

According to such a configuration, the information processing apparatus 20 can set a condition on an employee who can be in charge of loading or unloading the package, identify an employee who can be in charge of loading or unloading the package based on the condition, and issue a request to the employee to load or unload the package. Therefore, compared to a case in which any employee is requested to perform loading or the like of the package without imposing conditions on the employee who performs the loading or the like, the technology for transporting people and goods in mixed freight and passenger loads is improved by a reduction in the probability of inconveniences such as damage to packages occurring as a result of loading or the like being performed by an employee who does not meet the conditions.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like included in each component, each step, or the like can be rearranged without logical inconsistency, and a plurality of components, steps, or the like can be combined into one or divided.

For example, an embodiment in which the configuration and operations of the information processing apparatus 20 in the above embodiment are distributed to multiple computers capable of communicating with each other can be implemented. For example, an embodiment in which some or all of the components of the information processing apparatus 20 are provided in the vehicle 10 can also be implemented. For example, a navigation apparatus mounted in the vehicle 10 may be equipped with some or all of the components of the information processing apparatus 20.

For example, an embodiment in which a general purpose computer functions as the information processing apparatus 20 according to the above embodiment can also be implemented. Specifically, a program in which processes for realizing the functions of the information processing apparatus according to the above embodiment are written may be stored in a memory of a general purpose computer, and the program may be read and executed by a processor. Accordingly, the present disclosure can also be implemented as a program executable by a processor, or a non-transitory computer readable medium storing the program.

In the above embodiment, an example has been described in which an employee loads a package onto a vehicle at one stop (for example, stop 40A) and unloads the package from the vehicle at another stop (for example, stop 40B), i.e., an example in which the package is transported between stop 40A and stop 40B. However, employees may pick up the package in a building within the site, transport the package to one stop, and load the package onto a vehicle. Employees may also transport a package unloaded at another stop to the building that is the delivery destination. The reason is that in a case in which handling or transporting a particular package requires specialized knowledge, qualifications, experience, or the like, it is appropriate for the package to be transported by an employee with particular attributes.

In such cases, the controller 23 of the information processing apparatus 20 may formulate a transportation plan for the package that, in addition to the loading stop for the package, the loading time, the unloading stop, and the unloading time, also includes the pickup location for the package, the pickup time, the delivery location, and the delivery time. The communication interface 21 may also notify the mobile terminal 30 carried by the one or more employees, identified by the controller 23, of the package pickup or delivery request.

Information on the locations where packages are to be picked up and delivered may be map information. The mobile terminal 30 carried by the employee is configured to include at least one receiving module (for example, a receiving module compliant with GPS) compliant with a satellite positioning system. Thus, employees can use the map information received from the information processing apparatus 20 to transport a package from the location for pickup to the location for delivery, including loading onto the vehicle 10 and unloading from the vehicle 10, while taking into account the pickup time and delivery time.

As described above, the configuration and operations of the information processing apparatus 20 may be distributed to multiple computers capable of communicating with each other. The input interface 24 of the information processing apparatus 20 may be configured to include at least one interface for input that is capable of accepting an input from an employee. The interface for input is, for example, a physical key, a capacitive key, a pointing device, a touch screen integrally provided with the display, a barcode reader, an IC card reader, a microphone, or the like. Upon completion of the pickup or delivery, the employee may perform a predetermined operation on the input interface 24 of the information processing apparatus 20 installed in the building at the pickup location or delivery location to read the information stored on the employee identification card into the input interface 24. The predetermined operation refers, for example, to pressing a physical key or tapping an icon on the touch screen when the loading or unloading of the package is completed. Once the predetermined operation is performed, the input interface 64 requests reading of the employee identification card. A barcode printed on the employee identification card or an IC chip embedded in the employee identification card stores information on each employee's attributes, including the employee's department, job responsibilities, and work of which the employee is in charge. The input interface 24 may also record, with a microphone or the like, information on the attributes of speech uttered by the employee. Upon acquiring, from the input interface 24, the information stored on the employee identification card and inputted by performance of the predetermined operation by the employee who completed the work he or she was in charge of, the controller 23 of the information processing apparatus 20 determines that the employee in charge has completed the pickup or delivery of the package.

Examples of some embodiments of the present disclosure are described below. However, it should be noted that the embodiments of the present disclosure are not limited to these examples.
[Appendix 1] An information processing apparatus for managing loading or unloading of a package, the information processing apparatus comprising:
   a memory configured to store information on the package to be transported by a vehicle traveling within a site of a factory and attributes of each employee working at the factory;
   a controller configured to set a condition on an employee who can be in charge of loading or unloading the package and formulate a transportation plan for the package based on the information on the package, and identify at least one employee who has attributes satisfying the condition, from among one or more employees who are scheduled to ride in the vehicle that is to transport the package, based on the attributes of each employee and the condition on the employee who can be in charge of loading or unloading the package; and
   a communication interface configured to notify a mobile terminal carried by the at least one employee of a request for loading or unloading the package.
[Appendix 2] The information processing apparatus according to appendix 1, wherein when notifying of the request for loading or unloading the package, the communication interface is configured to notify the mobile terminal of the one or more employees of the transportation plan for the package, the transportation plan including a loading stop for the package, a loading time, an unloading stop, and an unloading time.
[Appendix 3] The information processing apparatus according to appendix 1 or 2, wherein in a case in which the one or more employees accept the request, the controller is configured to determine at least one employee from the one or more employees as an employee in charge of loading the package onto the vehicle or unloading the package from the vehicle.
[Appendix 4] The information processing apparatus according to appendix 3, wherein
   the communication interface is configured to receive, from the vehicle, information stored on an employee identification card of an employee who has completed loading or unloading the package, and
   the controller is configured to determine, upon acquiring the information, that the employee in charge has completed loading or unloading the package.
[Appendix 5] The information processing apparatus according to any one of appendices 1 to 4, wherein the attributes of the employee include at least one of a respective department, job responsibilities, work of which the employee is in charge, age, health status, and experience in handling equipment or materials that are the package.
[Appendix 6] The information processing apparatus according to appendix 2, wherein the information on the package includes at least one of a configuration of equipment or materials that are the package, handling information, a volume, a weight, a safety data sheet, a pickup location for the package, a pickup time, the loading stop, the loading time, the unloading stop, the unloading time, a delivery location, and a delivery time.
[Appendix 7] The information processing apparatus according to any one of appendices 1 to 6, wherein the condition includes at least a condition of having experience in handling equipment or materials that are the package.
[Appendix 8] An information processing method to be executed by an information processing apparatus for managing loading or unloading of a package, the information processing method comprising:
   storing information on the package to be transported by a vehicle traveling within a site of a factory and attributes of each employee working at the factory;
   setting a condition on an employee who can be in charge of loading or unloading the package based on the information on the package;
   formulating a transportation plan for the package based on the information on the package;
   identifying at least one employee who has attributes satisfying the condition, from among one or more employees who are scheduled to ride in the vehicle that is to transport the package, based on the attributes of each employee and the condition on the employee who can be in charge of loading or unloading the package; and
   notifying a mobile terminal carried by the at least one employee of a request for loading or unloading the package.
[Appendix 9] The information processing method according to appendix 8, wherein the notifying of the request for loading or unloading the package further includes notifying the mobile terminal of the one or more employees of the transportation plan for the package, the transportation plan including a loading stop for the package, a loading time, an unloading stop, and an unloading time.
[Appendix 10] The information processing method according to appendix 8 or 9, further comprising determining, in a case in which the one or more employees accept the request, at least one employee from the one or more employees as an employee in charge of loading the package onto the vehicle or unloading the package from the vehicle.
[Appendix 11] The information processing method according to appendix 10, further comprising
   receiving, from the vehicle, information stored on an employee identification card of an employee who has completed loading or unloading the package; and
   determining, upon acquiring the information, that the employee in charge has completed loading or unloading the package.
[Appendix 12] The information processing method according to any one of appendices 8 to 11, wherein the attributes of the employee include at least one of a respective department, job responsibilities, work of which the employee is in charge, age, health status, and experience in handling equipment or materials that are the package.
[Appendix 13] The information processing method according to appendix 9, wherein the information on the package includes at least one of a configuration of equipment or materials that are the package, handling information, a volume, a weight, a safety data sheet, a pickup location for the package, a pickup time, the loading stop, the loading time, the unloading stop, the unloading time, a delivery location, and a delivery time.
[Appendix 14] The information processing method according to any one of appendices 8 to 13, wherein the condition includes at least a condition of having experience in handling equipment or materials that are the package.
[Appendix 15] A non-transitory computer readable medium storing a program configured to cause an information processing apparatus for managing loading or unloading of a package to execute operations, the operations comprising:
   storing information on the package to be transported by a vehicle traveling within a site of a factory and attributes of each employee working at the factory;
   setting a condition on an employee who can be in charge of loading or unloading the package based on the information on the package;
   formulating a transportation plan for the package based on the information on the package;
   identifying at least one employee who has attributes satisfying the condition, from among one or more employees who are scheduled to ride in the vehicle that is to transport the package, based on the attributes of each employee and the condition on the employee who can be in charge of loading or unloading the package; and
   notifying a mobile terminal carried by the at least one employee of a request for loading or unloading the package.
[Appendix 16] The medium according to appendix 15, wherein the notifying of the request for loading or unloading the package further includes notifying the mobile terminal of the one or more employees of the transportation plan for the package, the transportation plan including a loading stop for the package, a loading time, an unloading stop, and an unloading time.
[Appendix 17] The medium according to appendix 15 or 16, wherein the operations further comprise determining, in a case in which the one or more employees accept the request, at least one employee from the one or more employees as an employee in charge of loading the package onto the vehicle or unloading the package from the vehicle.
[Appendix 18] The medium according to appendix 17, wherein the operations further comprise
   receiving, from the vehicle, information stored on an employee identification card of an employee who has completed loading or unloading the package; and
   determining, upon acquiring the information, that the employee in charge has completed loading or unloading the package.
[Appendix 19] The medium according to any one of appendices 15 to 18, wherein the attributes of the employee include at least one of a respective department, job responsibilities, work of which the employee is in charge, age, health status, and experience in handling equipment or materials that are the package.
[Appendix 20] The medium according to appendix 16, wherein the information on the package includes at least one of a configuration of equipment or materials that are the package, handling information, a volume, a weight, a safety data sheet, a pickup location for the package, a pickup time, the loading stop, the loading time, the unloading stop, the unloading time, a delivery location, and a delivery time.

1. An information processing apparatus for managing loading or unloading of a package, the information processing apparatus comprising:
a memory configured to store information on the package to be transported by a vehicle traveling within a site of a factory and attributes of each employee working at the factory;
a controller configured to set a condition on an employee who can be in charge of loading or unloading the package and formulate a transportation plan for the package based on the information on the package, and identify at least one employee who has attributes satisfying the condition, from among one or more employees who are scheduled to ride in the vehicle that is to transport the package, based on the attributes of each employee and the condition on the employee who can be in charge of loading or unloading the package; and
a communication interface configured to notify a mobile terminal carried by the at least one employee of a request for loading or unloading the package.

2. The information processing apparatus according to claim 1, wherein when notifying of the request for loading or unloading the package, the communication interface is configured to notify the mobile terminal of the one or more employees of the transportation plan for the package, the transportation plan including a loading stop for the package, a loading time, an unloading stop, and an unloading time.

3. The information processing apparatus according to claim 1, wherein in a case in which the one or more employees accept the request, the controller is configured to determine at least one employee from the one or more employees as an employee in charge of loading the package onto the vehicle or unloading the package from the vehicle.

4. The information processing apparatus according to claim 3, wherein
the communication interface is configured to receive, from the vehicle, information stored on an employee identification card of an employee who has completed loading or unloading the package, and
the controller is configured to determine, upon acquiring the information, that the employee in charge has completed loading or unloading the package.

5. The information processing apparatus according to claim 1, wherein the attributes of the employee include at least one of a respective department, job responsibilities, work of which the employee is in charge, age, health status, and experience in handling equipment or materials that are the package.

6. The information processing apparatus according to claim 2, wherein the information on the package includes at least one of a configuration of equipment or materials that are the package, handling information, a volume, a weight, a safety data sheet, a pickup location for the package, a pickup time, the loading stop, the loading time, the unloading stop, the unloading time, a delivery location, and a delivery time.

7. The information processing apparatus according to claim 1, wherein the condition includes at least a condition of having experience in handling equipment or materials that are the package.

8. An information processing method to be executed by an information processing apparatus for managing loading or unloading of a package, the information processing method comprising:
storing information on the package to be transported by a vehicle traveling within a site of a factory and attributes of each employee working at the factory;
setting a condition on an employee who can be in charge of loading or unloading the package based on the information on the package;
formulating a transportation plan for the package based on the information on the package;
identifying at least one employee who has attributes satisfying the condition, from among one or more employees who are scheduled to ride in the vehicle that is to transport the package, based on the attributes of each employee and the condition on the employee who can be in charge of loading or unloading the package; and
notifying a mobile terminal carried by the at least one employee of a request for loading or unloading the package.

9. The information processing method according to claim 8, wherein the notifying of the request for loading or unloading the package further includes notifying the mobile terminal of the one or more employees of the transportation plan for the package, the transportation plan including a loading stop for the package, a loading time, an unloading stop, and an unloading time.

10. The information processing method according to claim 8, further comprising determining, in a case in which the one or more employees accept the request, at least one employee from the one or more employees a s an employee in charge of loading the package onto the vehicle or unloading the package from the vehicle.

11. The information processing method according to claim 10, further comprising
receiving, from the vehicle, information stored on an employee identification card of an employee who has completed loading or unloading the package; and
determining, upon acquiring the information, that the employee in charge has completed loading or unloading the package.

12. The information processing method according to claim 8, wherein the attributes of the employee include at least one of a respective department, job responsibilities, work of which the employee is in charge, age, health status, and experience in handling equipment or materials that are the package.

13. The information processing method according to claim 9, wherein the information on the package includes at least one of a configuration of equipment or materials that are the package, handling information, a volume, a weight, a safety data sheet, a pickup location for the package, a pickup time, the loading stop, the loading time, the unloading stop, the unloading time, a delivery location, and a delivery time.

14. The information processing method according to claim 8, wherein the condition includes at least a condition of having experience in handling equipment or materials that are the package.

15. A non-transitory computer readable medium storing a program configured to cause an information processing apparatus for managing loading or unloading of a package to execute operations, the operations comprising:
storing information on the package to be transported by a vehicle traveling within a site of a factory and attributes of each employee working at the factory;
setting a condition on an employee who can be in charge of loading or unloading the package based on the information on the package;
formulating a transportation plan for the package based on the information on the package;
identifying at least one employee who has attributes satisfying the condition, from among one or more employees who are scheduled to ride in the vehicle that is to transport the package, based on the attributes of each employee and the condition on the employee who can be in charge of loading or unloading the package; and
notifying a mobile terminal carried by the at least one employee of a request for loading or unloading the package.

16. The medium according to claim 15, wherein the notifying of the request for loading or unloading the package further includes notifying the mobile terminal of the one or more employees of the transportation plan for the package, the transportation plan including a loading stop for the package, a loading time, an unloading stop, and an unloading time.

17. The medium according to claim 15, wherein the operations further comprise determining, in a case in which the one or more employees accept the request, at least one employee from the one or more employees as an employee in charge of loading the package onto the vehicle or unloading the package from the vehicle.

18. The medium according to claim 17, wherein the operations further comprise
receiving, from the vehicle, information stored on an employee identification card of an employee who has completed loading or unloading the package; and
determining, upon acquiring the information, that the employee in charge has completed loading or unloading the package.

19. The medium according to claim 15, wherein the attributes of the employee include at least one of a respective department, job responsibilities, work of which the employee is in charge, age, health status, and experience in handling equipment or materials that are the package.

20. The medium according to claim 16, wherein the information on the package includes at least one of a configuration of equipment or materials that are the package, handling information, a volume, a weight, a safety data sheet, a pickup location for the package, a pickup time, the loading stop, the loading time, the unloading stop, the unloading time, a delivery location, and a delivery time.
